(19) United States
(12) Patent Application Publication
(10) Pub. No.: US 2015/0088631 A1
(43) Pub. Date: Mar. 26, 2015

(54) SYSTEMS AND METHODS FOR CONSUMER STEERING BASED ON REAL-TIME TRANSACTION COST INFORMATION

(71) Applicant: ACI Worldwide, Inc., Elkhorn, NE (US)

(72) Inventor: Ben Mitchell, Auburn, AL (US)

(21) Appl. No.: 14/495,542

(22) Filed: Sep. 24, 2014

Related U.S. Application Data
(60) Provisional application No. 61/881,657, filed on Sep. 24, 2013.

(51) Int. Cl. G06Q 30/02; G06Q 20/10; G06Q 20/34; G06Q 20/36

(52) U.S. Cl. CPC G06Q 30/0222; G06Q 20/36; G06Q 20/108; G06Q 20/3572
USPC 705/14.23

(57) ABSTRACT

A computing device for consumer steering during a commercial transaction comprises a communication element, a memory element, and a processing element. The communication element communicates with a client computing device. The memory element stores a plurality of software components. The processing element executes software components including a cost analysis component for receiving original payment type information from a consumer and computing a cost score associated with the original payment type, a reward engine for determining a reward associated with an alternative payment type, an accept payment component for receiving information indicating either the original payment type or the alternative payment type, and a checkout component for transferring a receipt to the consumer and visually presenting the lost reward to the consumer if the original payment type was received or transferring the reward to the consumer if the alternative payment type was received.

### RELATED APPLICATION

The current non-provisional patent application claims priority benefit, with regard to all common subject matter, of an earlier-filed U.S. provisional patent application titled “SYSTEMS AND METHODS FOR CONSUMER STEERING BASED ON REAL-TIME TRANSACTION COST INFORMATION”, Application Ser. No. 61/881,657, filed Sep. 24, 2014. The earlier-filed application is hereby incorporated by reference into the current application in its entirety.

### BACKGROUND OF THE INVENTION

1. Field of the Invention

Embodiments of the current invention relate to systems and methods for electronically conducted commercial transactions.

2. Description of the Related Art

It is common for retailers and bill payment providers to promote loyalty and goodwill by providing consumers/users with incentives, rewards, etc. via marketing/selling tools to drive consumer behavior within their shopping experience. However, consumer steering is not extended to the checkout process when the consumer is deciding how to pay. The consumer's preferred method of payment is rarely the most cost effective means for the retailer or biller and possibly the consumer as well. The payment method is more often than not driven by external factors such as card issuer rewards, thereby rendering typical user interface processes (such as listing the retailer or biller preferred option first) ineffective.

### SUMMARY OF THE INVENTION

Embodiments of the current invention solve the above-mentioned problems and provide a distinct advance in the art of electronically conducted purchase transactions. More particularly, embodiments of the invention provide a system that presents a consumer with at least one alternative payment option at the time and point of sale when the consumer is making a purchase.

An embodiment of the system includes a computing device broadly comprising a communication element, a memory element, and a processing element. The communication element communicates with a client computing device through a communication network. The memory element stores a plurality of software components. The processing element is in communication with the communication element and the memory element. The processing element executes software components including a cost analysis component for receiving original payment type information from a consumer and computing a cost score associated with the original payment type, a reward engine for determining a reward associated with an alternative payment type, an accept payment component for receiving information indicating either the original payment type or the alternative payment type, and a checkout component for transferring a receipt to the consumer and visually presenting the lost reward to the consumer if the original payment type was received or transferring the reward to the consumer if the alternative payment type was received.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of a consumer steering system constructed in accordance with various embodiments of the current invention;

FIG. 2 is a schematic block diagram illustrating the relationship between components of the consumer steering system when the system is utilized in various transactions;

FIG. 3 is a flow diagram illustrating various aspects of a cost analysis software component of the consumer steering system;

FIG. 4 is a flow diagram illustrating various aspects of a reward software component of the consumer steering system;

FIG. 5 is a flow diagram illustrating various aspects of an accept payment software component of the consumer steering system;

FIG. 6 is a flow diagram illustrating various aspects of a checkout software component of the consumer steering system;

FIG. 7 is a block schematic diagram of a computing device which is a hardware component of the consumer steering system; and

FIG. 8 is a schematic block diagram of a payment processing system constructed in accordance with various embodiments of the current invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

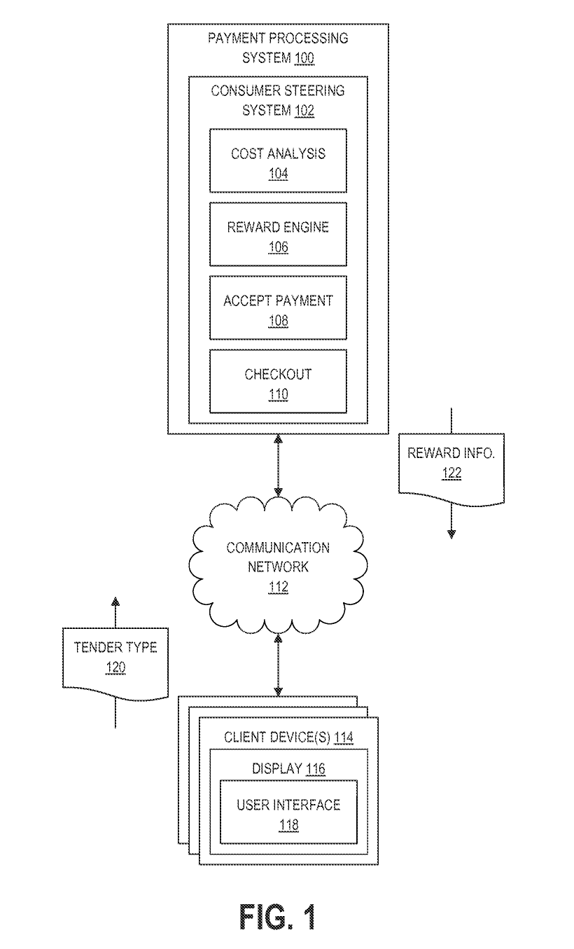

A description of a system for implementing consumer steering is now described followed by a discussion of the operation of the components within the system. FIG. 1 is a block diagram of a networked environment in which embodiments of a consumer steering system 102 may be implemented. A consumer steering system 102 is implemented as part of a payment processing system 100 that may be embodied, for example, as a server computer or any other system providing computing capability. The payment processing system 100 offers payment options to consumers for executing secure electronic payment to organizations, entities, etc. Note that the consumer steering system 102 may include a plurality of computing devices 103 that are arranged in one or more server banks or computer banks or other arrangements. For example, a plurality of computing devices 103 together may comprise a cloud computing resource, a grid computing resource, and/or any other distributed computing arrangement. An exemplary computing device 103 may include a display 105, a communication element 107, a memory element 109, and a processing element 111. In addition, the consumer steering system 102 may be communicatively coupled to a network 112. Furthermore, consumers may access the payment processing system 100 with a client computing device 114.

The display 105 may include video devices of the following types: plasma, light-emitting diode (LED), organic LED (OLED), Light Emitting Polymer (LEP) or Polymer LED (PLED), liquid crystal display (LCD), thin film transistor (TFT) LCD, LED side-lit or back-lit LCD, heads-up displays (HUDs), or the like, or combinations thereof. The display 105 may possess a square or a rectangular aspect ratio and may be viewed in either a landscape or a portrait mode. In various embodiments, the display 105 may also include a touch screen occupying the entire screen or a portion thereof so that the display 105 functions as part of a user interface. The touch screen may allow the user to interact with the computing device 103 by physically touching, swiping, or gesturing on areas of the screen.

The communication element 107 generally allows communication with external systems or devices. The communication element 107 may include signal or data transmitting and receiving circuits, such as antennas, amplifiers, filters, mixers, oscillators, digital signal processors (DSPs), and the like. The communication element 107 may establish communication wirelessly by utilizing radio frequency (RF) signals and/or data that comply with communication standards such as cellular 2G, 3G, or 4G, Institute of Electrical and Electronics Engineers (IEEE) 802.11 standard such as WiFi, IEEE 802.16 standard such as WiMAX, Bluetooth™, or combinations thereof. In addition, the communication element 107 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 107 may establish communication through connectors or couplers that receive metal conductor wires or cables which are compatible with technologies such as ethernet. The communication element 107 may also couple with optical fiber cables. The communication element 107 may be in communication with the processing element 111 and the memory element 109.

The memory element 109 may include data storage components such as read-only memory (ROM), programmable ROM, erasable programmable ROM, random-access memory (RAM) such as static RAM (SRAM) or dynamic RAM (DRAM), hard disks, floppy disks, optical disks, flash memory, thumb drives, universal serial bus (USB) drives, or the like, or combinations thereof. The memory element 109 may include, or may constitute, a “computer-readable medium”. The memory element 109 may store the instructions, code, code segments, software, firmware, programs, applications, apps, services, daemons, or the like that are executed by the processing element 111. The memory element 109 may also store settings, data, documents, sound files, photographs, movies, images, databases, and the like.

The processing element 111 may include processors, microprocessors, microcontrollers, digital signal processors (DSPs), field-programmable gate arrays (FPGAs), analog and/or digital application-specific integrated circuits (ASICs), or the like, or combinations thereof. The processing element 111 may generally execute, process, or run instructions, code, code segments, software, firmware, programs, applications, apps, processes, services, daemons, or the like. The processing element 111 may also include hardware components such as finite-state machines, sequential and combinational logic, and other electronic circuits that can perform the functions necessary for the operation of the current invention. The processing element 111 may be in communication with the other electronic components through serial or parallel links that include address busses, data busses, control lines, and the like.

The communication network 112 generally allows communication between the payment processing system 100 and the client computing devices 114. The communication network 112 may include local area networks, metro area networks, wide area networks, cloud networks, the Internet, and the like, or combinations thereof. The communication network 112 may be wired, wireless, or combinations thereof and may include components such as switches, routers, hubs, access points, and the like. The payment processing system 100 and the client computing devices 114 may connect to the communication network 112 either through wires, such as electrical cables or fiber optic cables, or wirelessly, such as radio frequency (RF) communication using wireless standards such as Bluetooth® or the Institute of Electrical and Electronic Engineers (IEEE) 802.11.

Through the network 112, the consumer steering system 102 is communicatively coupled to one or more client computing devices 114 operated by consumers. Each client computing device 114 may be substantially similar to the computing device 103. As shown, the client computing device 114 may comprise a display 116 and a user interface 118 for facilitating transactions with the payment processing system 100. Through the network 112, the client computing device 114 may transmit such data as a tender type 120 used for conducting electronic payment. As described in more detail below, the customer steering system 102 performs cost analysis and made transmit such data as reward information 122 back to the client computing device 114.

A plurality of software components executed on the consumer steering system 102 may include a cost analysis component 104, a reward engine component 106, an accept payment component 108, a checkout component 110, and other applications, services, processes, systems, engines, or functionality not discussed in detail herein. The software components 104, 106, 108, 110 may be executed on an exemplary computing device 103 by the processing element 111.

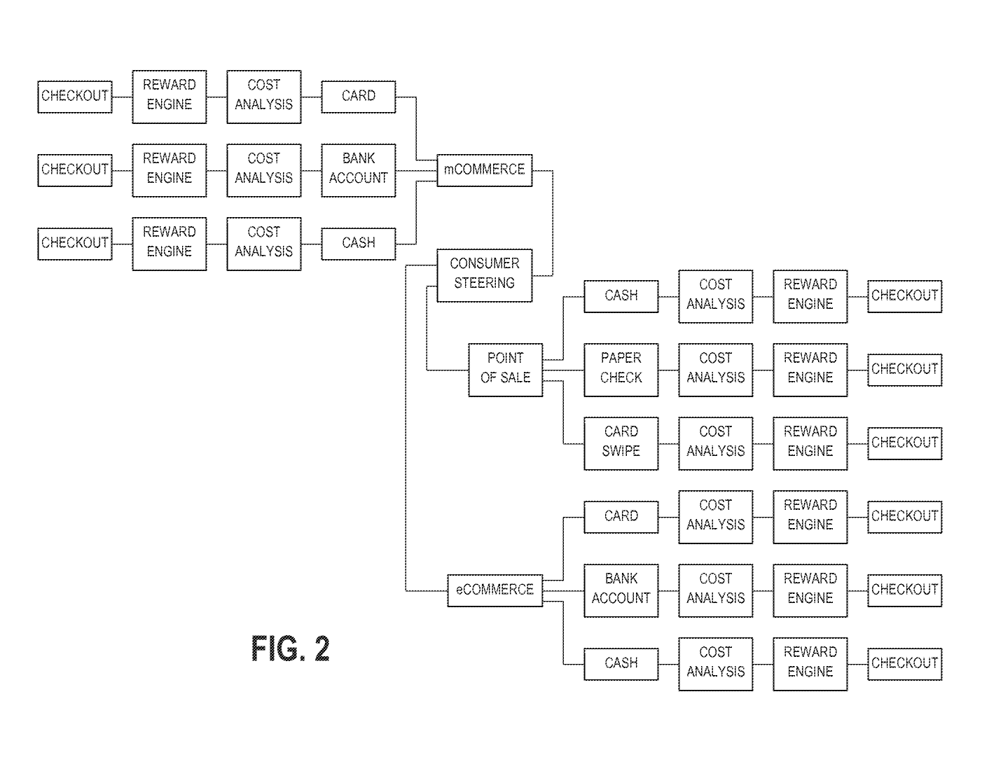

FIG. 2 illustrates the process flow between various components of the consumer steering system 102 of FIG. 1 in accordance with various embodiments of the present disclosure. As shown, the consumer steering system 102 may interface with various third parties such as a mobile commerce (mCommerce) entity, an electronic commerce (eCommerce) entity, point of sale (POS) entity), etc. and accept payment from client computing devices 114 in various forms including, for example, cash payments, checks, credit card payments, debit card payments, and so on.

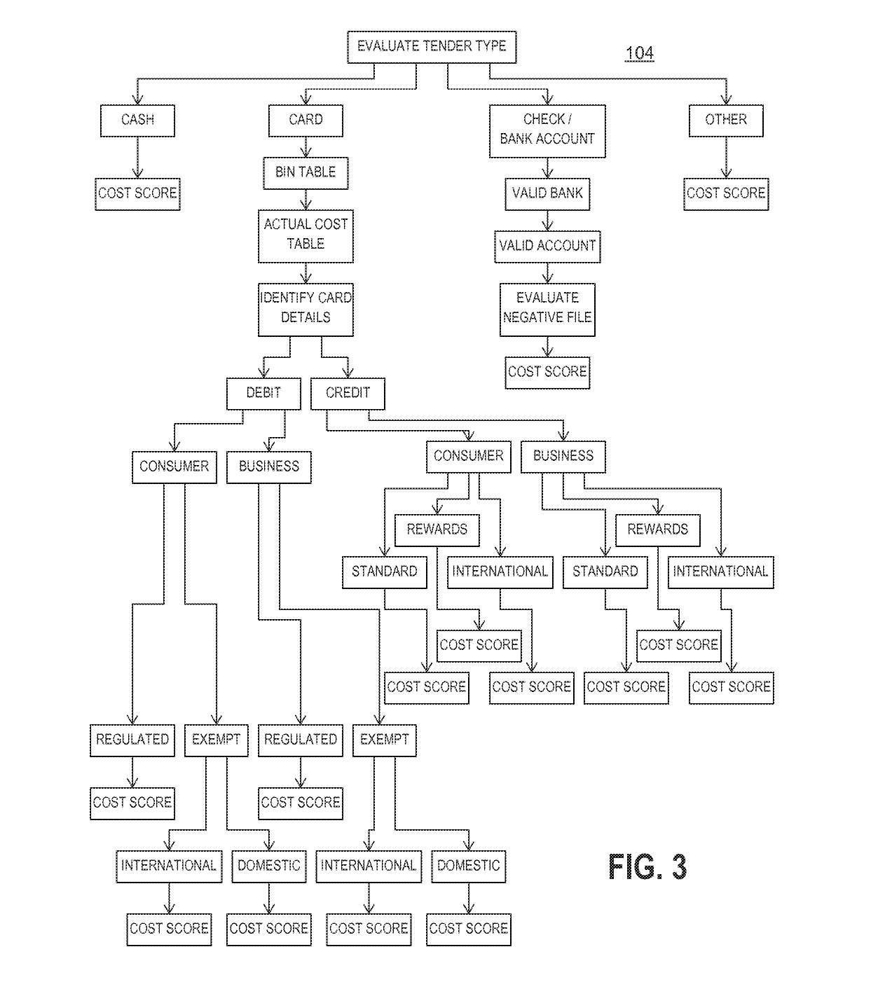

With reference to FIG. 3, the cost analysis component 104 evaluates a tender type or form of payment specified by the consumer. The tender types may include cash, a card, a check indicating a bank account, or an other type. For cash and the other types of tender, the cost analysis component 104 may directly calculate a cost score. If the tender type is a check, then the cost analysis component 104 may check the bank and account routing numbers, and analyze such attributes as a negative file, which may be a database of information on entities who have tried to execute a fraudulent transaction. If the tender type is a card indicated by a card number, the cost analysis component 104 may query a bank identification number (BIN) database to determine whether the card is debit or credit, consumer or business, international, domestic, standard, or rewards, and so forth. Furthermore, the cost analysis component 104 may query an actual cost database to determine if the card has been used previously and if there is a record of the previous transactional cost.

The cost analysis component 104 may evaluate the transaction cost associated with the tender type based on internal and external database data, Internet service data, etc. and determine the expected profitability of the transaction in addition to an accuracy measure score based on previously collected data and metrics. For some embodiments, the cost analysis component 104 may log the expected cost and profitably for assessment against actual cost. The actual cost data from down stream sources such as a bank, acquirer, etc. may later be received, and the cost analysis component 104 may then compare the expected cost versus the actual cost and log this data for future transactions. Based on the analyzed attributes, the cost analysis component 104 may assign a cost score to the specified tender type. Factors that may increase the cost score include previous chargebacks or returns, previous declines, previous assessments such as foreign card surcharges, mis-use fees, and the like. Other factors may include routing preferences, such as the consumer choosing to have a credit-card branded debit card transaction processed by the credit card company instead of the applicable debit networks. Factors that may decrease the cost score include negotiated volume commitments, marketing inputs, negotiated interchange and processing cost savings, and partner driven transactions.

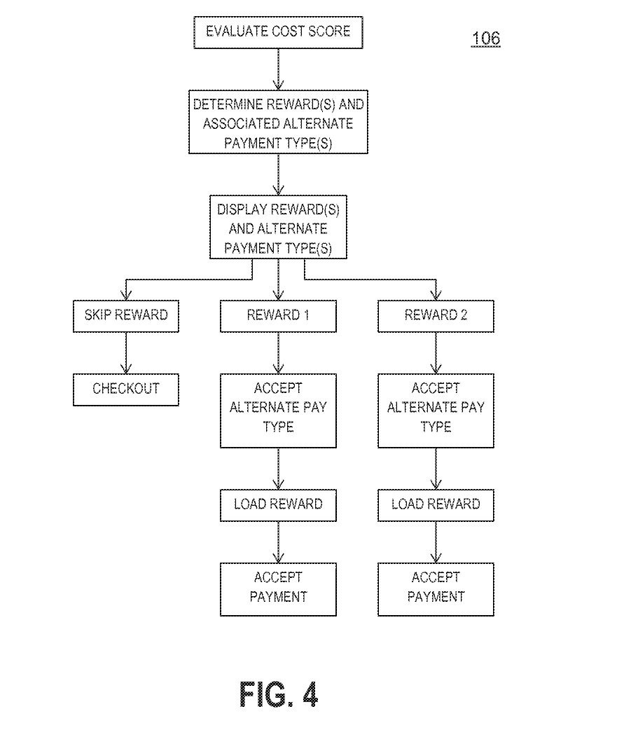

With reference to FIG. 4, the reward engine 106 receives the assigned cost score from the cost analysis component 104 and evaluates the cost score to determine one or more reward types to be presented to the consumer, where the reward type may comprise, for example, points or credit that the consumer may apply for the current transaction or a later transaction involving the payment processing system 100. The reward type may be associated with an alternative payment type that is different from the form of payment originally specified by the consumer. The reward type and the alternative payment type are presented to the consumer. The consumer receives the reward if the consumer is enticed to conduct the transaction using the alternative payment type.

In various embodiments, the reward engine 106 may determine a number of rewards, and alternative payment types, that varies according to the value of the cost score. For example, the reward engine 106 may determine one reward at a first value of the cost score, two rewards for a second value of the cost score greater than the first value, and so forth. It is also possible that the reward engine 106 might offer no rewards if the cost score is below a certain value.

The reward engine 106 may also retrieve or receive information from various sources, including credit card companies, retailers, banks, and the like, regarding rewards. Since this type of information is dynamic, the reward engine 106 may retrieve or receive the information on a regular basis.

For some embodiments, the cost analysis component 104 may match the consumer choice to proposed lower cost options to develop effectiveness measures. Such effectiveness measures may be used to evaluate the relevance of presented choices and modifications may then be made accordingly to further enhance consumer acceptance. The reward type and the alternative pay type may be presented to the consumer in the form of a user interface 118 shown on the display 116 of the client computing device 114. The user interface 118 may be embodied, for example, as a web page, email, or other form of electronic communication. As shown in FIG. 4, the consumer may also be given the option of skipping the reward and utilizing the originally-specified tender type.

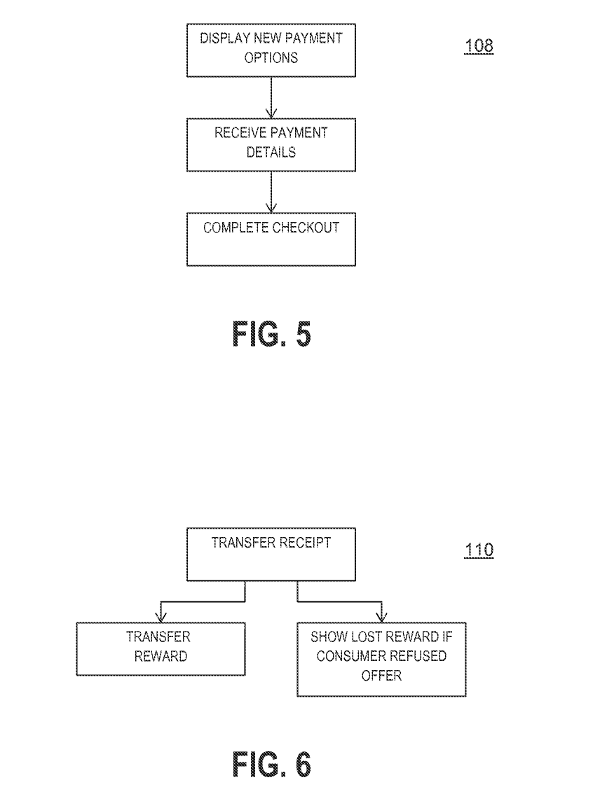

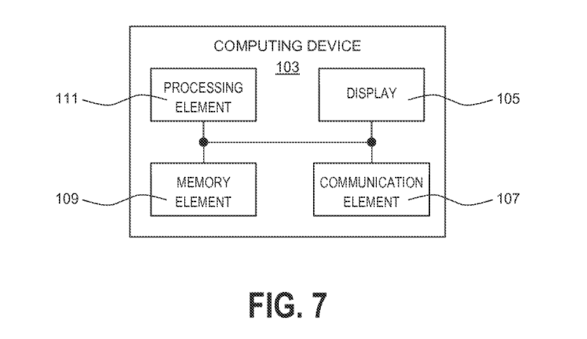

Reference is made to FIG. 5, which illustrates the process flow of the accept payment component 108. If the consumer elects to use one of the alternative tender types presented by the reward engine 106, the accept payment component 108 displays the new payment options associated with the alternative tender type. The consumer enters payment details and proceeds to checkout. If the consumer elects not to switch to one of the alternative tender types presented by the reward engine 106, then the process flows from the reward engine 106 directly to checkout.

FIG. 6 illustrates the process flow of the checkout component 110. If the consumer conducts the transaction using one of the alternative tender types provided by the reward engine 106, the checkout component 110 provides the corresponding reward to the consumer. A receipt for the transaction is generated, and the reward is delivered to the consumer via an electronic communication or other means. If the consumer conducts the transaction using the originally-specified tender type, the checkout component 110 may display the lost reward(s) to the consumer.

The payment processing system 100 may be implemented with one or more computing devices 103 of the consumer steering system 102 storing and executing the software components 104, 106, 108, 110. The computing device 103 may include web servers hosting a web site, mail servers sending and receiving electronic mail, or other servers or desktop computers. The computing device 103 executing the software components 104, 106, 108, 110 may be utilized by retailers, merchants, or others who interact directly with consumers offering goods, products, or services for sale. The software components 104, 106, 108, 110 may be executed by the processing element 111 of the computing device 103 in addition to other software programs, applications, and the like that manage commerce aspects, such as displaying images of merchandise, querying inventory databases, querying pricing databases, and so forth.

The consumer may utilize a client computing device 114 which communicates through the communication network 112 with the computing devices 103. The user interface 118 of the client computing device 114 may include such applications as a web browser, a mail program, or the like. As the consumer is ready to make a purchase, he may be visually presented with a prompt to make the payment. The consumer may indicate his first choice for making the payment, typically by clicking an option in the user interface 118. The first choice of payment option may be received by the cost analysis component 104, which determines a cost score based on factors discussed above. The reward engine 106 receives the cost score and determines an appropriate reward that is associated with an alternative form of payment. The reward engine 106 may also visually present the reward and the alternative payment type to the consumer on the user interface 118. Shown the potential reward associated with the alternative payment type, the consumer may reconsider his first choice of payment. If the consumer retains his first choice of payment, then the checkout component 110 may transfer the receipt to the consumer and may visually present information about the lost reward. If the consumer changes his choice of payment to the one associated with the reward, then the accept payment component 108 may accept the payment and visually present to the consumer information that verifies the payment type. The checkout component 110 may transfer the receipt to the consumer and may transfer, apply, or record the reward along with visually presenting it to the consumer.

In alternative embodiments, the computing devices 103 executing the software components 104, 106, 108, 110 may be utilized by a third party service who provides the steering services of the consumer steering system 102 to sellers (retailers, merchants, or others). The consumer may still interact with the seller such as by viewing the seller's website. When the consumer is ready to make a purchase, he may submit his payment choice to the seller, who in turn transfers the information to the third party service, which determines the cost score and the appropriate reward with an alternative payment. The third party service transmits that information back to the seller who sends it to the consumer. The process continues as described above with the seller acting as a data intermediary between the consumer and the third party service.

Embodiments of the current invention provide significantly more than the application of an abstract idea using a generic computer. The current invention provides improvements to the field of consumer steering in general and consumer steering during a commercial transaction in particular. Prior art approaches failed to provide consumer steering during a transaction. The current invention provides a computing device and software components that computes a cost score for a particular transaction based on the payment type chosen by the consumer and determines an appropriate reward associated with an alternative payment type. The computing device and software components then offer the consumer the option of choosing the alternative payment type and reward.

Embodiments of the current invention may include a computing device with a communication element, a memory element, and a processing element. The communication element may allow communication between the computing device and communication networks and client computing devices. The memory element may store software components, programs, applications, or instructions for the processing element to execute. The processing element may be programmed, utilizing programs in the memory element to perform selected functions. Specifically, the processing element of the current invention is programmed to provide consumer steering during a commercial transaction.

In addition, the computing device is necessary to perform the calculations needed to compute the cost score and determine an appropriate reward and alternative payment. It would require too much time for a human to perform, especially when a large number of transactions are involved. Furthermore, data may be received from client computing devices at times when humans are not able or willing to work.

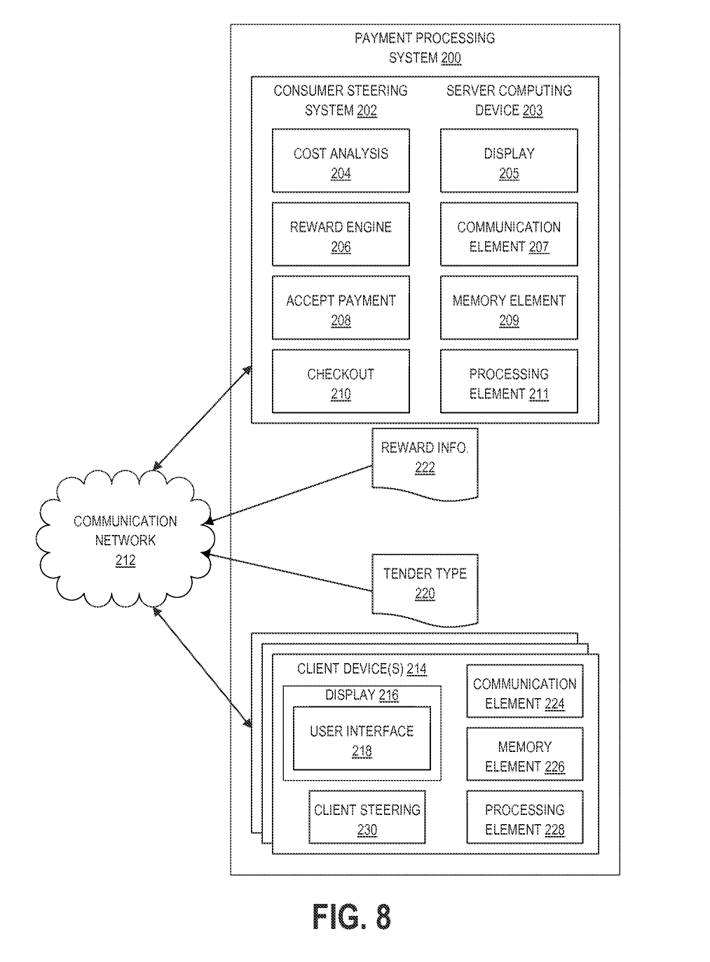

With reference to FIG. 8, an additional embodiment of the current invention provides a payment processing system 200 for consumer steering during a commercial transaction. The payment processing system 200 broadly comprises a consumer steering system 202, a cost analysis component 204, a reward engine 206, an accept payment component 208, a checkout component 210, one or more computing devices 203 each with a display 205, a communication element 207, a memory element 209, and processing element 211, and one or more client computing devices 214 each with a display 216 and a user interface 218. In addition, the devices 203, 214 may communicate through a communication network 212. Furthermore, the consumer steering system 202 may provide reward information 222 and the client computing devices 214 may provide a tender type 220. All of the listed components may be substantially similar to the like-named components discussed above for the payment processing system 100. The computing device 203 may be referred to as a server computing device 203.

Each client computing device 214 may be best embodied by a mobile electronic device such as a smart phone, a smart watch, a tablet, etc., and may further include a communication element 224 substantially similar to communication element 107, a memory element 226 substantially similar to memory element 109, and a processing element 228 substantially similar to processing element 111. Each client computing device 214 may also include a client steering (software) component 230 which may be stored in the memory element 226 and may be executed by the processing element 228. The client steering component 230 may allow the current invention to interact with emerging digital wallet or electronic wallet (eWallet) technologies and applications such as CurrentC™ from Merchant Customer Exchange (MCX), Checkout from Visa, Apple Pay from Apple, Google Wallet from Google, and the like. The client steering component 230 may receive information from the eWallet application that a commercial transaction is about to be initiated. The server software components 204, 206, 208, 210 may also receive information from the eWallet application that a commercial transaction is about to be initiated. Based on information regarding payment options for the transaction, the reward engine 206 may communicate reward and alternative payment information to the client steering component 230. In some embodiments, the client steering component 230 may automatically select the reward and alternative payment and may communicate that information to the accept payment component 208, the eWallet application, or both. In other embodiments, the client steering component 230 may automatically sort the payment/tender types so that the best option for the consumer is presented first and may communicate the sorted list of payment types to the eWallet application. The eWallet application may then present the sorted payment list to the consumer.

The payment processing system 200 may operate as follows. The consumer may have a client computing device 214 which may execute an eWallet application as well as the client steering component 230. The client computing device 214 may communicate, through the communication element 224 and in turn the communication network 212, with external devices and systems that handle electronic commercial transactions for a seller, such as a merchant or retailer, which may be located in a store or retail outlet. The client computing device 214 may also communicate with the consumer steering system 202 and one or more server computing devices 203. When the consumer wants to make a purchase, the eWallet application may communicate with the seller's systems and the one or more server computing devices 203. The eWallet application may receive pricing and payment option information. The client steering component 230 and the server software components 204, 206, 208, 210 may also receive the pricing and payment option information. The cost analysis component 204 may determine a cost score for all of the payment options. The reward engine 206 may receive the cost scores and may determine one or more alternative payment types and associated rewards. Each reward may include or be assigned a value. The reward engine 206 may communicate this information to the client steering component 230. In some embodiments, the client steering component 230 may automatically select the reward and alternative payment with the greatest value and may communicate that information to the accept payment component 208, the eWallet application, or both. In other embodiments, the client steering component 230 may automatically sort the payment/tender types so that the best option for the consumer is presented first and may communicate the sorted list of payment types to the eWallet application. The eWallet application may then present the sorted payment list to the consumer, at which point, the consumer may choose a payment type. The payment information may be communicated to the accept payment component 208, the eWallet application, or both. The checkout component 210 may transfer the receipt to the consumer. If the consumer chose a payment type with a reward, then the reward may be transferred or applied. If the consumer chose a payment type without a reward, then information regarding the lost reward may be visually presented to the consumer.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A computing device for consumer steering during a commercial transaction, the computing device comprising:
a communication element configured to communicate with a client computing device through a communication network;
a memory element storing a plurality of software components; and
a processing element in communication with the communication element and the memory element, the processing element configured to execute a plurality of software components including:
a cost analysis component for receiving original payment type information from a consumer utilizing the client computing device, and computing a cost score associated with the original payment type,
a reward engine for determining a reward associated with an alternative payment type, different from the original payment type, and visually presenting the reward and the alternative payment type to the consumer,
an accept payment component for receiving information from the consumer indicating either the original payment type or the alternative payment type, and
a checkout component for transferring a receipt to the consumer and visually presenting the lost reward to the consumer if the original payment type was received or transferring the reward to the consumer if the alternative payment type was received.

2. The computing device of claim 1, wherein the cost analysis component further verifies bank and account routing numbers for an original payment type that includes a check.

3. The computing device of claim 1, wherein the cost analysis component further analyzes a negative file including a database of information on entities who have tried to execute a fraudulent transaction for an original payment type that includes a check.

4. The computing device of claim 1, wherein the cost analysis component further queries a bank identification number database to determine a type of card being used for an original payment type that includes a card number.

5. The computing device of claim 1, wherein the cost analysis component further queries an actual cost database to determine if a card being used has been used previously and if there is a record of the previous transactional cost for an original payment type that includes a card number.

6. The computing device of claim 1, wherein the reward engine receives information regarding reward offers from retailers and credit card companies.

7. A system for consumer steering during a commercial transaction, the system comprising:
a server computing device including
a communication element configured to communicate with a client computing device through a communication network;
a memory element storing a plurality of software components; and
a processing element in communication with the communication element and the memory element, the processing element configured to execute a plurality of software components including:
a cost analysis component for receiving information regarding a plurality of payment types from the client computing device, and computing a cost score associated with each payment type,
a reward engine for determining at least one reward associated with an alternative payment type and a value, different from the original payment types, and communicating the at least one reward and the at least one alternative payment type to the client computing device,
an accept payment component for receiving information from the client computing device indicating one of the payment types, and
a checkout component for transferring a receipt to the consumer and visually presenting the lost reward to the consumer if a payment type without a reward was received or transferring the reward to the consumer if a payment type with a reward was received; and
a client computing device including
a communication element configured to communicate with the server computing device through the communication network;
a memory element storing at least one software component; and
a processing element in communication with the communication element and the memory element, the processing element configured to execute an electronic wallet application which enables electronic commercial transactions and a client steering component for receiving the at least one reward, the associated alternative payment type, and the associated value.

8. The system of claim 7, wherein the client steering component further selects the at least one reward and associated payment type with the greatest value, and communicates the selected reward and associated payment type to the server computing device.

9. The system of claim 7, wherein the client steering component further sorts the at least one reward at least one reward and associated payment type so that the reward and associated payment type with the greatest value is presented first and communicates the sorted rewards and associated payment types to the electronic wallet application.

10. The system of claim 7, wherein the cost analysis component further verifies bank and account routing numbers for a payment type that includes a check.

11. The system of claim 7, wherein the cost analysis component further analyzes a negative file including a database of information on entities who have tried to execute a fraudulent transaction for a payment type that includes a check.

12. The system of claim 7, wherein the cost analysis component further queries a bank identification number database to determine a type of card being used for a payment type that includes a card number.

13. The system of claim 7, wherein the cost analysis component further queries an actual cost database to determine if a card being used has been used previously and if there is a record of the previous transactional cost for a payment type that includes a card number.

14. The system of claim 7, wherein the reward engine receives information regarding reward offers from retailers and credit card companies.

15. A non-transitory computer-readable storage medium with an executable program stored thereon, wherein the program instructs a processing element to perform the following steps:
receiving original payment type information from a consumer utilizing the client computing device;
computing a cost score associated with the original payment type;
determining a reward associated with an alternative payment type, different from the original payment type;
visually presenting the reward and the alternative payment type to the consumer;
receiving information from the consumer indicating either the original payment type or the alternative payment type;
transferring a receipt to the consumer; and
visually presenting the lost reward to the consumer if the original payment type was received or transferring the reward to the consumer if the alternative payment type was received.

16. The non-transitory computer-readable storage medium of claim 15, wherein the program further instructs the processing element to verify bank and account routing numbers for an original payment type that includes a check.

17. The non-transitory computer-readable storage medium of claim 15, wherein the program further instructs the processing element to analyze a negative file including a database of information on entities who have tried to execute a fraudulent transaction for an original payment type that includes a check.

18. The non-transitory computer-readable storage medium of claim 15, wherein the program further instructs the processing element to query a bank identification number database to determine a type of card being used for an original payment type that includes a card number.

19. The non-transitory computer-readable storage medium of claim 15, wherein the program further instructs the processing element to query an actual cost database to determine if a card being used has been used previously and if there is a record of the previous transactional cost for an original payment type that includes a card number.

20. The non-transitory computer-readable storage medium of claim 15, wherein the program further instructs the processing element to receive information regarding reward offers from retailers and credit card companies.
